(19) United States
(12) Patent Application Publication
(10) Pub. No.: US 2016/0236591 A1
(43) Pub. Date: Aug. 18, 2016

(54) METHOD FOR PRESETTING A VEHICLE SEAT

(71) Applicants: JOHNSON CONTROLS GMBH, Burscheid (DE); TECHNISCHE UNIVERSITÄT MÜNCHEN, München (DE)

(72) Inventors: Wei Lange-Mao, Hagen (DE); Florian Kremser, München (DE); Fabian Guenzkofer, Kirchdorf a. d. Amper (DE); Susanne Frohriep, Langenfeld (DE)

(73) Assignees: Johnson Controls GMBH, Burscheid (DE); Technische Universitat Munchen, Munchen (DE)

(21) Appl. No.: 15/027,088

(22) PCT Filed: Sep. 26, 2014
(86) PCT No.: PCT/EP2014/070689

§ 371 Date: Apr. 4, 2016

(30) Foreign Application Priority Data
Oct. 4, 2013 (DE) 10 2013 016 323.4
May 15, 2014 (DE) 10 2014 209 250.7

(51) Int. Cl. B60N 2/02

(52) U.S. Cl. CPC B60N 2/0244; B60N 2002/0268

(57) ABSTRACT

The invention relates to a method for presetting a vehicle seat (1) for a passenger (2) using the vehicle seat. Said vehicle seat comprises at least parts of a presetting device (12). The invention is characterized in that in a first step, information about the passenger is transmitted to the presetting device transmits and in a second step, the vehicle seat (1) is modified by said presetting device (12) such that the vehicle seat (1) adopts as the presetting for the passenger (2), a first vehicle seat configuration based on the transmitted information.

### PRIOR ART

The present invention related to a method for presetting vehicle seats.

Many passengers of vehicles do not set the correct vehicle seat configuration when using their vehicle seat. In particular, on relatively long journeys the unsuitable selection of the vehicle seat configuration can lead to back pain and leg difficulties. In an accident situation there is also the risk of an incorrectly set vehicle seat protecting the passenger less than a correctly set vehicle seat. This relates, in particular, to components of the vehicle seat whose setting does not implement a considerable improvement in comfort, and these components are therefore rarely set by the passenger on a regular basis. An example of such a component is a headrest which is intended to prevent excessive extension of neck vertebra of the passenger in an accident situation. It is therefore desirable for the vehicle seat to independently assume a vehicle seat configuration which is individually adapted and as far as possible optimum if the passenger is going to use the vehicle seat. In particular, such a presetting is desirable if the vehicle seat is regularly used by alternating passengers such as is the case, for example, with family cars, pool, vehicles of a company, rental vehicles or vehicles involved in car sharing.

The prior art includes, for example from document WO 2012/048 100 A2, a method for setting seats on the basis of a set of information which has to be determined in a laborious fashion and processed by means of complicated algorithms. For example, said document proposes superimposing an image of the user on a measuring template in order to detect the set of information.

### DISCLOSURE OF THE INVENTION

The object of the present invention is to make available a method by means of which the passenger is provided with a presetting of his vehicle seat in an uncomplicated way, wherein the passenger must at most only slightly correct the presetting. It would be advantageous here if the presetting can also be performed when the passenger uses the vehicle for the first time and before the passenger sits down in the vehicle seat. Furthermore, it would be desirable if the passenger could return to the presetting of his seat again, for example by activating a knob.

The object is achieved by means of a method for presetting a vehicle seat, wherein the vehicle seat comprises at least parts of a presetting device, wherein in a first method step information about the passenger is transmitted to the presetting device, characterized in that in a second method step the vehicle seat is changed by means of the presetting device in such a way that the vehicle seat assumes, as a presetting for the passenger, a first vehicle seat configuration which is based on the transmitted information.

An advantage of the present invention is that the vehicle seat independently assumes a first vehicle seat configuration which serves as a presetting for the passenger. In particulars to do this the passenger does not have to have sat down in the vehicle seat, and the presetting is carried out completely automatically by the presetting device. Furthermore, laborious measuring methods such as, for example, the use of measuring templates in order to obtain the necessary information for the presetting of the vehicle seat, is advantageously dispensed with. In particular, the passenger is relieved of the need to perform laborious activation of the means for changing the vehicle seat configuration, which are usually difficult to access. In particular there is provision that in the second method step a backrest of the vehicle seat is pivoted, a height setting of a sitting surface is changed, and an inclination of the sitting surface and/or a distance of the vehicle seat from a steering wheel of the vehicle are/is changed. In this context it is also conceivable for the depth of the sitting surface to be modified. In particular, one or more changes take place in an electronically controlled fashion. In particular, in the second method step the headrest is moved into a position which is adapted to the passenger, wherein the headrest can be pivoted, for example, about a pivoting axis and vertically adjusted relative to the sitting surface. The presetting device preferably comprises a multiplicity of motors for implementing the presetting of the vehicle seat.

Advantageous refinements and developments of the invention can be found in the dependent claims as well as the description with reference to the drawings.

In one preferred embodiment of the present invention, there is provision that the information about the passenger comprises the body size thereof. In particular, it is provided that the body size is the only information. A primary presetting of the vehicle seat is preferably made solely on the basis of the body size. As a a result it is advantageously possible to dispense with laboriously determining or inputting other dimensions (apart from the body size) by means of cameras, touchscreens or the like. Howevers it is also conceivable that the information comprises other additional anthropometric data of the passenger which can be used as a preference, in order to achieve an even more individual seat setting in a secondary presetting of the vehicle seat. It is advantageous here compared to the prior art that the presetting device requires only a manageable number of data items, in particular only the body size, in order to set the vehicle seat as satisfactorily as possible. However, it is also conceivable for the information also to comprise the passenger's gender, and for the vehicle seat to be preset in a way which is adapted to the passenger's gender. Furthermore, it is conceivable for the information to comprise the passenger's weight.

In a further embodiment, there is provision that the vehicle seat comprises a fine-setting device, and in a third method step the vehicle seat is transferred from the first vehicle seat configuration to a second vehicle seat configuration using the fine-setting device. As a result, the correct and most comfortable setting for the vehicle seat can advantageously be set by the passenger. In particular, the passenger can adjust the vehicle seat according to his requirements and preferences. Thanks to the setting in the first vehicle seat configuration, only very small changes are required. Preferably, it is sufficient if the passenger changes a single variable which determines the vehicle seat configuration. As a result, the passenger can advantageously save time during the setting of the vehicle seat.

In a further embodiment there is provision that the presetting in the second method step is carried out on the basis of an algorithm, wherein the algorithm is based on simulations and/or empirical values. The algorithm preferably uses empirical values which have been obtained in advance within the scope of experiments or studies and/or simulations. In particular, the presetting is performed on the basis of simulations and by means of investigations carried out on test subjects. It is also conceivable that the algorithm is refreshed or at least partially renewed in the form of an update after a certain amount of time. Preferably, only the information about the body size of the passenger is required by the algorithm to define the first vehicle seat configuration. In particular there is provision that a type of vehicle, the surroundings of the vehicle seat, a general sitting behavior of passengers and/or the gender of the passenger are also taken into account in the empirical values.

In a further embodiment there is provision that the information about the passenger is transmitted to the presetting device from

an external source,

a sensor element which is mounted on the vehicle seat,

a sensor element which is mounted in the surroundings of the vehicle seat, and/or

a capacitive sensor. Examples of an external source are mobile terminals such as, for example, mobile phones, smartphones, tablets or a camera which is arranged, for example, in a residence of the vehicle owner or in the vicinity of the vehicle. In particular it is conceivable that the mobile terminal has an application which can communicate with an on-board computer and/or a control device of the vehicle and/or directly with the presetting device. In this context it is also conceivable that information is transmitted from a database in which the information is stored. The sensors may be, for example, cameras which are directed at the passenger who is getting into the vehicle or is seated in the vehicle.

In a further embodiment there is provision that further information is transmitted in the first method step, and in the second method step the further information is used for presetting the vehicle seat. For example, in addition to the body size, another anthropometric feature of the passenger is also transmitted, as a result of which allowance can be made in an advantageous way for the complexity of the human body during the presetting. As a result, the presetting can be optimized further. It is also conceivable that the passenger can optionally preselect between different possibilities, relating to the driving style, for the presetting of the vehicle seat. For example, the passenger can decide on a sporty or an economic driving style, and the corresponding presetting of the vehicle seat can be selected and assumed on the basis of the passenger's selection.

In a further embodiment there is provision that in a fourth method step a first vehicle seat configuration or second vehicle seat configuration assumed according to the second method step or according to the third method step is stored in a memory unit, preferably under an ID, as a vehicle seat position together with the information received in the first method step, and in a fifth method step the stored vehicle seat position is set by means of the presetting device and/or the fine-setting device if the stored information is transmitted again to the presetting device. As a result, the setting of the vehicle seat can be advantageously reproduced for the passenger if the passenger would like to use the vehicle seat again. It is also conceivable that the stored vehicle seat position is stored in an external memory unit, for example in a customer account of a rental vehicle company. The presetting device preferably has a communication means for communicating with the external memory unit, and receives the information for presetting via this communication means. However, it is also conceivable that the stored vehicle seat position is retrieved again if a reference value, which has been stored along with the stored vehicle seat position, is transmitted to the on-board computer or the presetting device. It is also conceivable that a vehicle seat position is stored for a passenger and the stored vehicle seat position is proposed to a further passenger as an alternative vehicle seat configuration to the first vehicle seat configuration if the information about the passenger and a further passenger transmitted in the first method step is similar. As a result, the passenger is advantageously assisted in selecting the setting for the vehicle seat.

In a further embodiment there is provision that a warning signal is generated if a deviation of the first vehicle seat configuration from the second vehicle seat configuration exceeds a critical value. As a result, the passenger can be advantageously alerted to the fact that the selection which has been made for his vehicle seat configuration is capable of improvement for technical safety reasons, as a result of which the safety of the vehicle seat is increased further.

In a further embodiment there is provision that in the second method step a further component of the vehicle assumes a first component configuration on the basis of the information from the first method step, wherein the setting of the further components can also be adjusted individually for the passenger. In the second method step, the automatic and independent orientation of the steering wheel, of a side mirror and/or of the central rear view mirror, for example, could be carried out.

A further subject matter of the present invention is a presetting device for presetting a vehicle seat for a passenger, wherein the presetting device is configured in such a way that information can be recorded by the presetting device, and the vehicle seat can be transferred automatically to a vehicle seat position by means of the presetting device.

A further subject matter of the present invention is a software program, wherein the software program has an algorithm which is based on empirical values. As a result, the setting of the vehicle seat can advantageously be implemented as satisfactorily as possible. In this context, the software can be integrated into a seat control device, into an infotainment system and/or into an external unit. In this context, the presetting is preferably communicated to the seat control device via a bus system or a wireless system.

Further details, features and advantages of the invention can be found in the drawings and in the following description of preferred embodiments with reference to the drawings. The drawings illustrate here merely exemplary embodiments of the invention which do not restrict the essential inventive concept.

### BRIEF DESCRIPTION OF THE FIGURES

FIG. 1 shows in schematic form a first exemplary method for presetting a vehicle seat according to the present invention.

FIG. 2 shows a block diagram of a second exemplary method for presetting a vehicle seat according to the present invention, and

FIG. 3 shows a method for determining empirical values which serve to preset a vehicle seat according to the present invention.

### EMBODIMENTS OF THE INVENTION

In the various figures, identical parts are always provided with the same reference symbols and are therefore as a rule also each specified or mentioned only once.

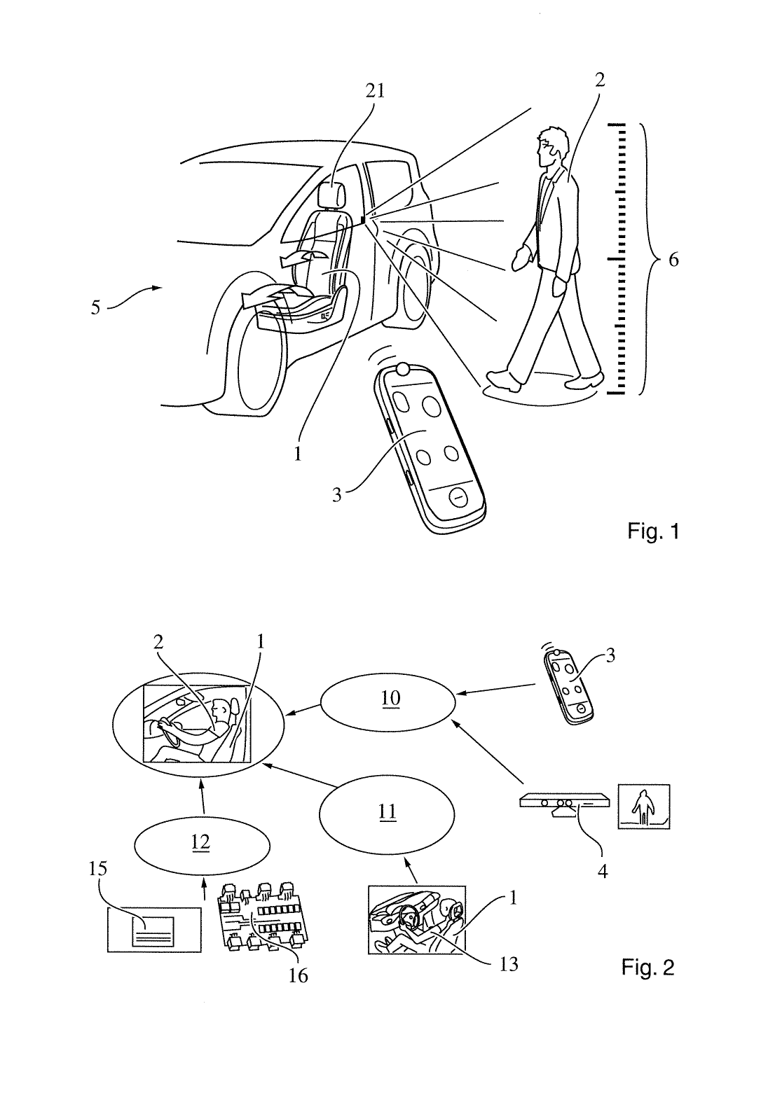

FIG. 1 illustrates a first exemplary method for presetting a vehicle seat 1 according to the present invention. There is provision here that in a first method step information 10 about a passenger 2 is transmitted to a presetting device 12 which is arranged on the vehicle seat 1, wherein the passenger is in the process of getting into a vehicle 5. In this context, the vehicle comprises the vehicle seat. For example, the presetting device 12 receives the information 10 from a sensor element 4 which is arranged on the vehicle 5. However, it is also conceivable that the presetting device 12 receives the information 10 from an external source 3. External sources 3 may be, for example, a smartphone with a suitable application or a tablet. The passenger 2 preferably enters his body size 6 into the application, and the information “body size” 6 is transmitted to the presetting device 12. However, it is also conceivable that a sensor element 4 is arranged on the vehicle seat 1 or on the vehicle 5, wherein the sensor element 4 transmits the information 10 on the body size 6. It is also conceivable that the presetting device 12 has already stored the body size 6 of the passenger 2 under a reference term, and the reference term is input into the application and the presetting device 12 performs the presetting on the basis of the reference term. It is, for example, conceivable that a fingerprint is stored as a reference for the body size 6, and the fingerprint is measured by a fingerprint sensor on the vehicle and is transmitted to the presetting device 12. In particular, there is provision that the vehicle seat 1 is transferred to a first vehicle seat configuration by means of the presetting device 12 on the basis of the received information, in particular on the basis of the body size 6, the weight or the driving style of the passenger. For this purpose, a backrest is preferably pivoted relative to a sitting surface of the vehicle seat, it is also conceivable that the vehicle seat 1 is shifted in a longitudinal direction relative to a bodywork of the vehicle and/or the height setting of the vehicle seat is changed. It is also conceivable that the seat depth or seat inclination is changed. A setting for a headrest 21 of the vehicle seat 1 preferably also forms part of the first vehicle configuration.

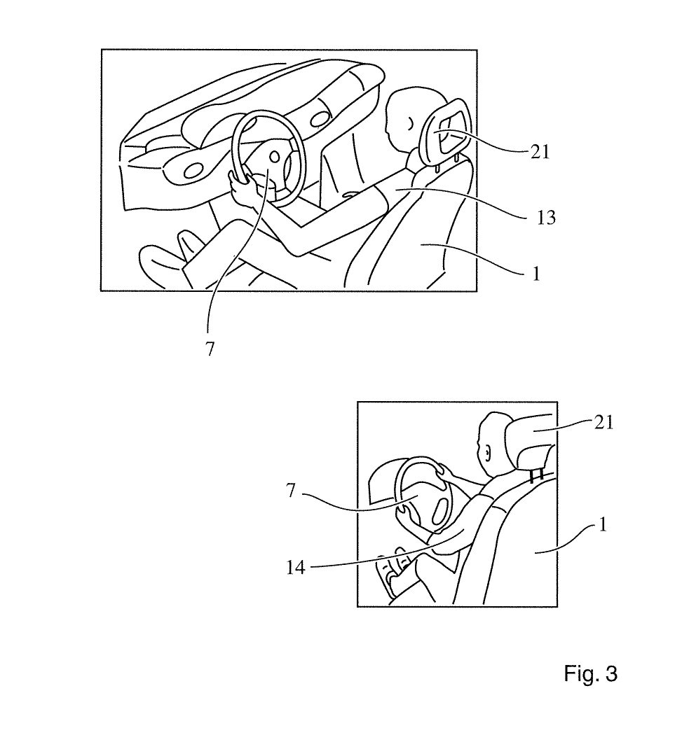

FIG. 2 is a schematic illustration, in a block diagram, of a second exemplary embodiment of the method according to the present invention. There is provision that the body size 6 and/or other anthropometric data of the passenger 2 are used for the presetting. The presetting device 12 preferably receives the information 10 about the body size 6 or about other anthropometric data of the passenger 2. However, it is also conceivable that an on-board computer of the vehicle 5 receives the data or the information first, wherein the on-board computer has a communicative connection to the presetting device 12 and the on-board computer decides about the presetting and transmits the data, required for presetting, as information 10 to the presetting device 12. The information which comprises the body size 6 and/or other anthropometric data may have been sent, for example, from a mobile radio terminal or a sensor element 4 or a system composed of sensor elements. In particular, the system composed of sensor elements 4 can be a camera system. The system composed of sensor elements 4 or the sensor element 4 preferably evaluates the measured values directly, determines the body size 6 or other anthropometric data and transmits it as information 10 to the on-board computer or directly to the presetting device 12. Furthermore, there is provision that the on-board computer or the presetting device 12 has an analysis device, wherein the analysis device selects a first vehicle seat configuration on the basis of the received information about the body size 6 and/or about other anthropometric data of the passenger, wherein the first vehicle seat configuration is adapted to the body size 6 and/or to other anthropometric data. In particular, there is provision that the first vehicle seat configuration is determined by the analysis device on the basis of an algorithm. The algorithm will preferably define the first vehicle seat configuration on the basis of empirically detected values. The empirical values are preferably included as parameters, in the sense of values 11 gained from experience, in the algorithm. Furthermore, both a hardware component 15 and a software component 16 are provided, wherein the software component comprises the algorithm and the analysis device, and the hardware component comprises means for adjusting the vehicle seat.

FIG. 3 shows by way of example methods for determining empirical values 11, wherein the empirical values 11 are used for the algorithm which defines the first vehicle seat configuration. In a first method for determining empirical values 11, the passenger is simulated using a test dummy 13, and on the basis of the simulation in the second method step an optimum first vehicle seat configuration is determined for the passenger 2. This is illustrated in the top illustration in FIG. 3. In a second method for determining empirical values 11, different test subjects 14 are positioned as passengers in the vehicle seat and are used to select a presetting for the vehicle seat configuration. This is illustrated in the bottom illustration in FIG. 3. In a third method for determining empirical values 11, the passenger 2 is simulated on a computer. A combination of the presented methods for determining empirical values 11 for the algorithm is preferably used. In particular, the settings are selected on the basis of empirical, in particular ergoncroic, investigations and knowledge.

### LIST OF REFERENCE NUMBERS

1 Vehicle seat

2 Passenger

3 External source

4 Sensor element

5 Vehicle

6 Body size

7 Steering wheel

10 Information

11 Empirical values

12 Presetting device

13 Dummy

14 Test person

15 Part of software

16 Part of hardware

21 Headrest

1. A method for presetting a vehicle seat for a passenger using the vehicle seat, wherein the vehicle seat comprises at least parts of a presetting device, wherein in a first method step, information about the passenger is transmitted to the presetting device, wherein in a second method step the vehicle seat changed by means of the presetting device in such a way that the vehicle seat assumes, as a presetting for the passenger, a first vehicle seat configuration which is based on the transmitted information.

2. The method as claimed in claim 1, wherein the information about the passenger comprises the body size thereof.

3. The method as claimed in claim 1, wherein the vehicle seat comprises a fine-setting device, and in a third method step the vehicle seat is transferred from the first vehicle seat configuration to a second vehicle seat configuration using the fine-setting device.

4. The method as claimed in claim 1, wherein the presetting in the second method step is carried out on the basis of an algorithm, wherein the algorithm is based on simulations and/or empirical values.

5. The method as claimed in claim 1, wherein the information about the passenger is transmitted to the presetting device from;
a) an external source,
b) a sensor element which is mounted on the vehicle seat,
c) a sensor element which is mounted in the surroundings of the vehicle seat,
d) a prestored database, and/or
e) a capacitive sensor,

6. The method as claimed in claim 1, wherein further information is transmitted in the first method step, and in the second method step the further information is used for presetting the vehicle seat.

7. The method as claimed in claim 3, wherein in a fourth method step, the first vehicle seat configuration or the second vehicle seat configuration assumed according to the second method step or according to the third method step is stored in a memory unit as a stored, vehicle seat position together with the information received in the first method step, and in a fifth method step the stored vehicle seat position is set by means of the presetting device and/or the fine-setting device if the stored information is transmitted again to the presetting device.

8. The method as claimed in claim 3, wherein a warning signal is generated if a deviation of the first vehicle seat configuration from the second vehicle seat configuration exceeds a critical value.

9. The method as claimed in claim 1, wherein in the second method step, a further component of the vehicle assumes a first component configuration on the basis of the information from the first method step.

10. A presetting device for presetting a vehicle seat for a passenger, wherein the presetting device is configured in such a way that information can be recorded by the presetting device, and the vehicle seat can be transferred automatically to a vehicle seat position by means of the presetting device.

11. A software program for the presetting device as claimed in claim 10.
